(19) United States
(12) Patent Application Publication
(10) Pub. No.: US 2023/0227602 A1
(43) Pub. Date: Jul. 20, 2023

(54) Benzocyclobutene curatives for low thermal expansion thermosets

(71) Applicant: National Technology & Engineering Solutions of Sandia, LLC, Albuquerque, NM (US)

(72) Inventors: Jeffrey Clayton Foster, Albuquerque, NM (US); Erica Marie Redline, Albuquerque, NM (US); Koushik Ghosh, Albuquerque, NM (US); Chad Staiger, Albuquerque, NM (US)

(21) Appl. No.: 18/098,168

(22) Filed: Jan. 18, 2023

Related U.S. Application Data
(60) Provisional application No. 63/300,769, filed on Jan. 19, 2022.

(51) Int. Cl. C08G 59/40

(52) U.S. Cl. CPC C08G 59/4007

(57) ABSTRACT

A method to synthesize a low thermal expansion thermoset comprises mixing a thermosetting resin and a benzocyclobutene curative having a reactive secondary functionalization; heating the mixture to a first temperature to from a pre-polymer comprising benzocyclobutene end groups and a thermoset linking group; and heating the pre-polymer to a second temperature sufficient for ring-opening of benzocyclobutene to occur, thereby forming a thermoset polymer network crosslinked with dibenzocyclooctene moieties.

### CROSS-REFERENCE TO RELATED APPLICATION

This application claims the benefit of U.S. Provisional Application No. 63/300,769, filed Jan. 19, 2022, which is incorporated herein by reference.

### STATEMENT OF GOVERNMENT INTEREST

This invention was made with Government support under Contract No. DE-NA0003525 awarded by the United States Department of Energy/National Nuclear Security Administration. The Government has certain rights in the invention.

### FIELD OF THE INVENTION

The present invention relates to crosslinked polymers with tunable coefficients of thermal expansion and, in particular, to use of benzocyclobutene curatives for low thermal expansion thermosets.

### BACKGROUND OF THE INVENTION

Dibenzocyclooctene (DBCO, also referred to as dibenzocyclooctane) and derivatives thereof have been shown to be useful organic compounds to manipulate the thermal expansion behavior of polymer networks (e.g., cured epoxies). As illustrated in FIG. 1, a strategy to manipulate the coefficient of thermal expansion (CTE) of thermosets involves covalent incorporation of thermally contractile units, such as DBCO, within a polymer network. DBCO, comprising a flexible cyclooctene ring connecting two rigid phenyl or aromatic groups, undergoes a reversible twist-boat to chair isomerization upon heating accompanied by a decrease in molecular volume. See X. Shen et al., Nat. Chem. 5(12), 1035 (2013); Z. Wang et al., Macromolecules 51(4), 1377 (2018); and W. Fu et al., J. Am. Chem. Soc. 142(39), 16651 (2020). These conformational “shrinking” linkages oppose thermal expansion during heating, with the net effect of reducing the CTE of the polymer to near or less than zero in some cases.

Recently, the DBCO moiety has been used to prepare di-aniline crosslinkers for use in epoxy/amine thermosets. See Pub. No. US 2021/0387987 A1, which is incorporated herein by reference. Depending on the regioisomer (or positional isomer) of cis-diamino-DBCO utilized as a crosslinker, epoxy thermosets were prepared with near-zero, or in some cases negative, CTE values that feature highly reversible thermal expansion and contraction behavior. However, these DBCO compounds are difficult to access from a synthetic perspective.

### SUMMARY OF THE INVENTION

The present invention is directed to a method to synthesize a low thermal expansion thermoset, comprising mixing a thermosetting resin and a benzocyclobutene curative having a reactive secondary functionalization; heating the mixture to a first temperature to from a pre-polymer comprising benzocyclobutene end groups and a thermoset linking group; and heating the pre-polymer to a second temperature sufficient for ring-opening of benzocyclobutene to occur, thereby forming a thermoset polymer network crosslinked with dibenzocyclooctene moieties. For example, the thermosetting resin can comprise an epoxy, acrylate, methacrylate, polyester, vinyl ester, polyamide, polyimide, or urethane. For example, the reactive secondary functionalization can comprise aniline, amine, carboxylic acid, alcohol, isocyanate, anhydride, epoxide, acyl chloride, or carbonyl.

### BRIEF DESCRIPTION OF THE DRAWINGS

The detailed description will refer to the following drawings, wherein like elements are referred to by like numbers.

FIG. 1 is a schematic illustration of thermally controlled isomerization of DBCO between twist-boat and chair conformers and how the incorporation of such contractile units into thermoset materials influences their thermal expansion and contraction behavior.

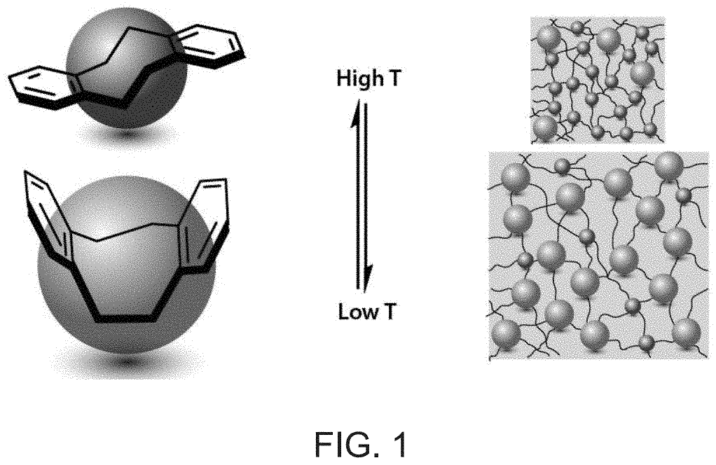

FIG. 2 is an illustration of a thermal isomerization process of benzocyclobutene based on a self-Diels-Alder reaction. See M. Komeda et al., J. Polym. Sci. A Polym. Chem. 57, 2175 (2019).

FIG. 3 is an illustration of a method to synthesize aniline-functionalized benzocyclobutene (BCB).

FIG. 4 is an illustration of a method to synthesize a DCBO-containing epoxy network from an epoxy resin and an aniline-functionalized BCB curative.

FIG. 5 is an illustration of BCB curatives.

FIG. 6 is an illustration of a generalized method to synthesize a DCBO-containing polymer network from a thermosetting resin and a BCB curative.

### DETAILED DESCRIPTION OF THE INVENTION

According to the present invention, benzocyclobutene (BCB) monomers and prepolymers can be used as a curative to prepare low CTE thermosets. BCBs undergo thermal dimerization to form benzocyclooctene (BCO) units and can be synthesized in a few steps from commercially-available precursors. As a result, BCB chemistry can be used as a handle to tune curing temperature and material properties (e.g., CTE, thermal stability, thermal transitions, etc.).

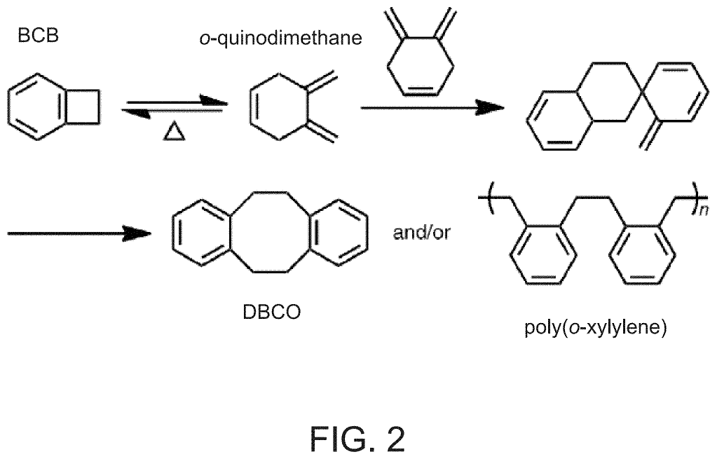

As shown in FIG. 2, the strained cyclobutene ring of BCBs can undergo a contrary ring-opening reaction upon heating to form an o-quinodimethane intermediate which can then undergo a number of additional reactions such as radical addition or cycloaddition. See M. Komeda et al., J. Polym. Sci. A Polym. Chem. 57, 2175 (2019). Dimerization of the o-quinodimethane intermediate produces dibenzocyclooctene (DBCO), which undergoes boat-to-chair isomerization upon heating, as described above. Thus, BCBs can serve as precursors to DBCOs in the preparation of low CTE materials.

BCBs are often employed as crosslinking moieties, installed pendant to the polymer backbone or at the polymer chain ends. Upon heating such BCB-functionalized precursors, polymer networks are formed that are typically characterized by low dielectric constants and excellent thermal stability. See R. A. Kirchhoff et al., J. Macromol. Sci. A Chem. 28(11-12), 1079 (1991); and R. A. Kirchhoff and K. J. Bruza, Prog. Polym. Sci. 18(1), 85 (1993). BCB-based polymer networks have been noted to possess low CTE values (ca. <40 ppm/K), but have not been used explicitly for the purpose of creating low CTE materials. See Y. Cheng et al., ACS Appl. Polym. Mater. 1(10), 2622 (2019); Q. Xianfeng et al., High Perf. Polym. 31, 1062 (2019); and R. A. Kirchhoff et al., J. Macromol. Sci. A Chem. 28(11-12), 1079 (1991).

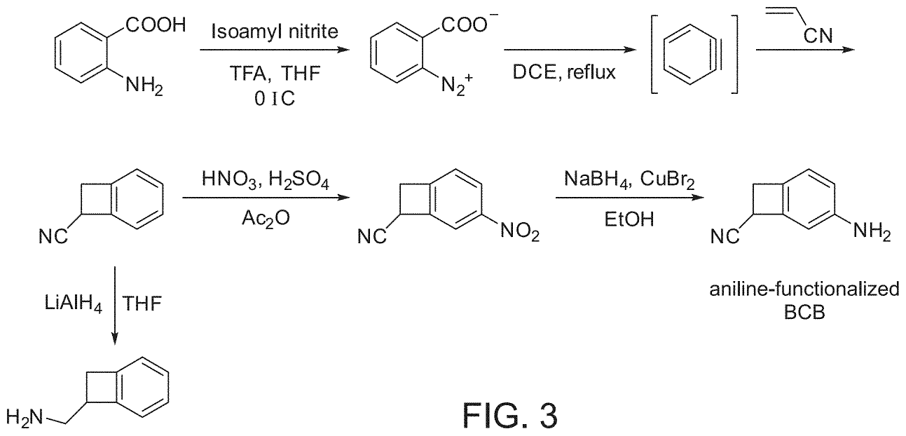

As shown in FIG. 3, an aniline-functionalized BCB can be synthesized in three discreet steps from commercially available anthranilic acid. In the first step, anthranilic acid is converted to the corresponding benzenediazonium salt using isoamyl nitrite catalyzed by trifluoroacetic acid (TFA) in tetrahydrofuran (THF) at 0° C. After careful filtration (the solids should be kept wet with solvent to avoid explosion) of the resulting precipitate and thorough washing with dichloroethane (DCE), the solids are resuspended in dichloroethane, acrylonitrile is added, and 1-cyanobenzocyclobutene is then prepared via cycloaddition with acrylonitrile. Nitration of 1-cyanobenzocyclobutene with HNO₃ in the presence of catalytic H₂SO₄ and acetic anhydride as the solvent gives the 2-nitro product selectively, which is reduced to the 2-aniline-functionalized BCB using NaBH₄ and a Cu(II)Br₂ catalyst.

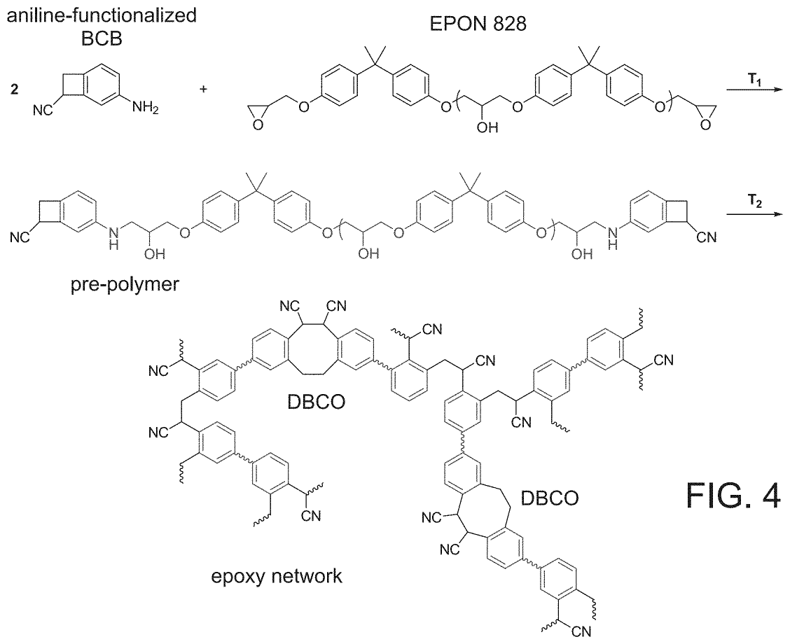

The present invention is directed to the use of BCB and derivatives thereof as curatives to prepare low CTE polymer networks. As shown in FIG. 4, an exemplary epoxy-based network can be prepared using the following two-step process:

Step 1, carried out at a first temperature, T₁ (T₁<T₂), involves formation of a pre-polymer comprising BCB end groups and an epoxy linking group via reaction of a secondary functionality on the BCB, such as the 2-aniline-functionalized BCB curative described above, with an epoxy resin, such as EPON 828. For example, T₁ can be about 60° C.

Step 2, carried out at a second temperature, T₂, involves heating of the pre-polymer to a sufficient temperature for BCB ring-opening to occur, thereby forming an epoxy network crosslinked with DCBO moieties with cis aniline substitutions. For example, T₂ can be about 180° C.

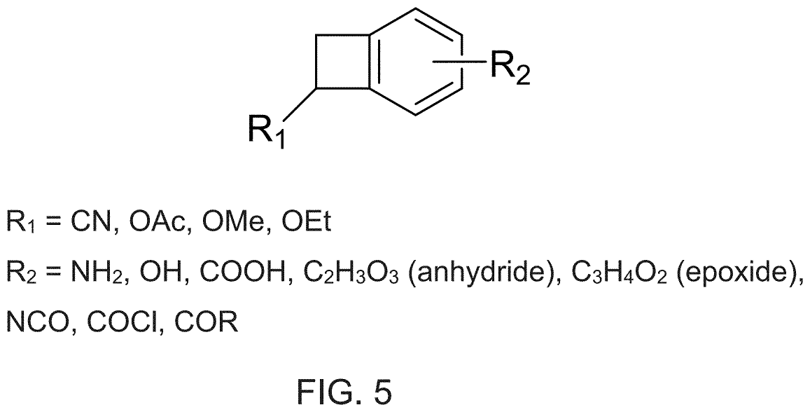

Other pre-polymer chemistries are possible. In general, the resin can comprise any thermosetting resin, including but not limited to epoxy resins, acrylates, methacrylates, polyesters, vinyl esters, polyam ides, polyim ides, and urethanes, and other crosslinked polymer systems to provide a tunable coefficient of thermal expansion. As shown in FIG. 5, the BCB curative can be substituted with a variety of reactive secondary functionalities R₂ on the aromatic ring, including amines, carboxylic acids, alcohols, isocyanates, anhydrides, epoxides, acyl chloride, or carbonyl (COR, R=H, R=alkyl), etc. In addition, different groups R₁ can be attached to the cyclobutene ring, which can influence the temperature at which ring-opening occurs. For example, R₁ can be a cyano, acetyloxy, methoxy, or ethoxy group.

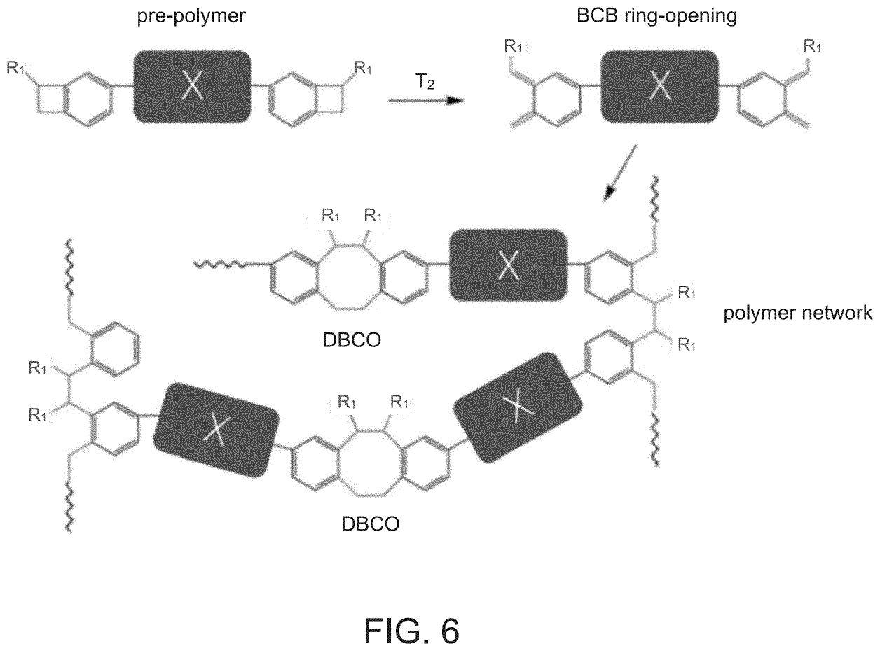

In a generalized two-step process, a thermosetting resin can be reacted with a BCB curative at a temperature T₁ to form a pre-polymer with a thermoset linking group X and BCB end groups, as shown in FIG. 6. The pre-polymer can then be heated to a sufficient temperature T₂ for BCB ring-opening to occur, resulting in a thermosetting polymer network crosslinked with DCBO moieties.

The present invention has been described as the use of benzocyclobutene and derivatives thereof as a curative for low thermal expansion thermosets. It will be understood that the above description is merely illustrative of the applications of the principles of the present invention, the scope of which is to be determined by the claims viewed in light of the specification. Other variants and modifications of the invention will be apparent to those of skill in the art.

We claim:

1. A method to synthesize a low thermal expansion thermoset, comprising:
mixing a thermosetting resin and a benzocyclobutene curative having a reactive secondary functionalization;
heating the mixture to a first temperature to from a pre-polymer comprising benzocyclobutene end groups and a thermoset linking group: and heating the pre-polymer to a second temperature sufficient for ring-opening of benzocyclobutene to occur, thereby forming a thermoset polymer network crosslinked with dibenzocyclooctene moieties.

2. The method of claim 1, wherein the thermosetting resin comprises an epoxy.

3. The method of claim 1, wherein the thermosetting resin comprises an acrylate, methacrylate, polyester, vinyl ester, polyamide, polyimide, or urethane.

4. The method of claim 1, wherein the reactive secondary functionalization comprises aniline.

5. The method of claim 1, wherein the reactive secondary functionalization comprises an amine, carboxylic acid, alcohol, isocyanate, anhydride, epoxide, acyl chloride, or carbonyl.

6. The method of claim 1, wherein the cyclobutene ring of the benzocyclobutene is functionalized with a cyano, acetyloxy, methoxy, or ethoxy group.
